(19) United States
(12) Patent Application Publication
(10) Pub. No.: US 2008/0259007 A1
(43) Pub. Date: Oct. 23, 2008

(54) METHOD FOR DYNAMICALLY ADJUSTING BRIGHTNESS OF IMAGE

(75) Inventors: Kao-Yi Chiu, Taipei (TW); Li-Hsiang Liao, Taipei (TW); Yu-Hsuan Lai, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/106,332

(22) Filed: Apr. 21, 2008

(30) Foreign Application Priority Data
Apr. 20, 2007 (TW) 96113978

(51) Int. Cl. G09G 3/30

(52) U.S. Cl. 345/77

(57) ABSTRACT

A method for dynamically adjusting the brightness of an image is provided. In the method, a plurality of first pixel values of pixels in a captured display image are converted to a plurality of first brightness values when an application program is executed with a full screen picture. Then, the size and the distribution of the first brightness values are adjusted to obtain a plurality of second brightness values. Afterward, the second brightness values are converted to a plurality of second pixel values with which the pixels of the display image and displayed on the screen are overwritten. Therefore, the brightness of each display image can be dynamically adjusted, which is convenient.

### CROSS-REFERENCE TO RELATED APPLICATION

This application claims the priority benefit of Taiwan application serial no. 96113978, filed on Apr. 20, 2007. The entirety the above-mentioned patent application is hereby incorporated by reference herein and made a part of specification.

### BACKGROUND OF THE INVENTION

1. Field of the Invention

The invention relates to a method for adjusting the brightness of an image and, more particularly, to a method for dynamically adjusting the brightness of an image when a program is executed with a full screen picture.

2. Description of the Related Art

In the present society with the high science and technology, electronic products gradually enter the daily life of people. For example, a television and a game for providing entertainment and a computer for working all show that people rely on the electronic products in daily life. For the requirement of the work or the entertainment in daily life, a displaying device such as a television, a projector, a liquid crystal display and so on is an essential electronic product.

To allow a user to have a comfortable visual sense, the displaying device usually has a built-in adjustment function, and then the user can adjust displaying states according to his requirement. Functions of adjusting the brightness and contrast of an image are often used. As for an adjustment mode, the most common method is that the user presses down a function key provided on the displaying device to call an adjustment interface to adjust the brightness or contrast of the image.

The above method is only used to adjust the whole brightness or contrast of an image displayed by a device itself, and it cannot make corresponding adjustment for content displayed in the image. When the user wants to execute an application program with a full screen picture, he can only selectively adjust the brightness and contrast of the image via function options provided by the application program first before the application program is executed. For example, if the executed application program is a game program, the user needs to adjust the brightness or contrast of a display image by selecting system setting options at the beginning of starting the game program. Then, when the game program is executed later, the user can see a wanted image.

The above method can only make the same adjustment for all display images, and it cannot make dynamic adjustment in compliance with brightness changes of the content of each display image. For example, as for the execution of a game program, when game scenes change from day to night, the brightness of the original display image greatly decreases. If the user is unaccustomed to or does not want to see the dark image, he needs to adjust the brightness of the display image. At that moment, he may press down the function key on the screen to gradually adjust the brightness manually. However, if the game scenes continuously change along with the process of the game, the above method is relatively clumsy and unpractical.

### BRIEF SUMMARY OF THE INVENTION

The invention provides a method for dynamically adjusting the brightness of an image, and the method can dynamically adjust the brightness of an image when an application program is executed with a full screen picture.

The method for dynamically adjusting the brightness of the image provided by the invention includes the steps described hereinbelow. First, the application program is executed to enter a full screen picture. Next, a plurality of first pixel values of a plurality of pixels of a display image which is intended to be displayed by the full screen picture are captured. Then, the first pixel values of the pixels are converted to first brightness values, and the size and distribution of the first brightness values are adjusted to obtain second brightness values. Afterward, the second brightness values of the pixels are converted to second pixel values. Finally, the display image is displayed, and the pixel values of the pixels of the display image are the second pixel values.

In one embodiment of the invention, the method further includes the step of capturing display images which is intended to be displayed by a full screen picture every a constant number of display images, and repeats the above step of dynamically adjusting the brightness of the image. And first brightness values of each displayed images are cooperated with the second brightness values conversion obtained from the size and distribution.

In one embodiment of the invention, the method further includes the steps of storing the first pixel values to a system memory after the step of capturing the first pixel values of the pixels of the display image which is intended to be displayed by the full screen picture, and overwriting the first pixel values stored in the system memory with the second pixel values after the step of converting the second brightness values of the pixels to the second pixel values.

In one embodiment of the invention, the method further includes the step of adjusting resolution of the display image before the step of converting the first pixel values of the pixels to the first brightness values. And the step of adjusting the resolution of the display image includes the step of scaling the display image according to a predetermined scale or the steps of equally dividing the display image into a plurality of macro blocks and scaling the macro blocks according to a predetermined scale.

In one embodiment of the invention, the method further includes the steps of obtaining an image histogram by statistics according to the resolution of the adjusted display image and adjusting the size and distribution of the first brightness values according to the image histogram after the step of adjusting the resolution of the display image. The step of obtaining the image histogram by statistics includes the steps of counting the number of the pixels whose pixel values are one of the first brightness values, respectively, to compute a probability density function of each of the first brightness values and obtaining the image histogram by combining each first brightness value and its corresponding probability density function.

In one embodiment of the invention, the above step of adjusting the size and distribution of the first brightness values includes the step of equally distributing the first brightness values into a brightness range of the image histogram according to the image histogram. The step of equally distributing the first brightness values into the brightness range of the image histogram includes the steps of mapping a minimum value of the first brightness values to a minimum brightness value of the brightness range, mapping a maximum value of the first brightness values to a maximum brightness value of the brightness range and mapping the other first brightness values to corresponding brightness values of the brightness range.

In one embodiment of the invention, the step of adjusting the size and distribution of the first brightness values includes the step of equalizing the image histogram, wherein the step of equalizing the image histogram includes the step of equally distributing the first brightness values to the brightness range to obtain the second brightness values, and then the first brightness values of the pixels are mapped to the second brightness values.

The method of the invention is carried out when an application program is executed with a full screen picture. Each display image is captured first before displayed, and then the brightness is adjusted to be in a range of brightness values, and finally, the adjusted display image is displayed by a screen. Therefore, the method of the invention can dynamically adjust the brightness of each display image according to the distribution of the brightness of each display image. No matter how the brightness of the display image changes, the method of the invention can automatically adjust each display image to have appropriate brightness, and therefore, the method of the invention is very convenient.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a flow chart showing steps of a method for dynamically adjusting the brightness of an image according to one embodiment of the invention;

FIG. 2 and FIG. 3 are schematic diagrams showing that an image is scaled according to one embodiment of the invention; and

FIG. 4A to FIG. 4D are schematic diagrams showing image histograms according to one embodiment of the invention.

### DETAILED DESCRIPTION OF THE EMBODIMENTS

The brightness of a display image on a screen changes along with different executed application programs or changed scenes. Each display image has its corresponding brightness distribution. If information of the brightness distribution can be captured and be appropriately adjusted before the display image is displayed, however the brightness of the display image changes, the brightness of the display image can be adjusted to an ideal brightness range. The invention provides a method for dynamically adjusting the brightness of an image under a full screen according to the above theory. To make the content of the invention to be further clear, an embodiment of the invention is illustrated to show that the invention can be put into practice hereinbelow.

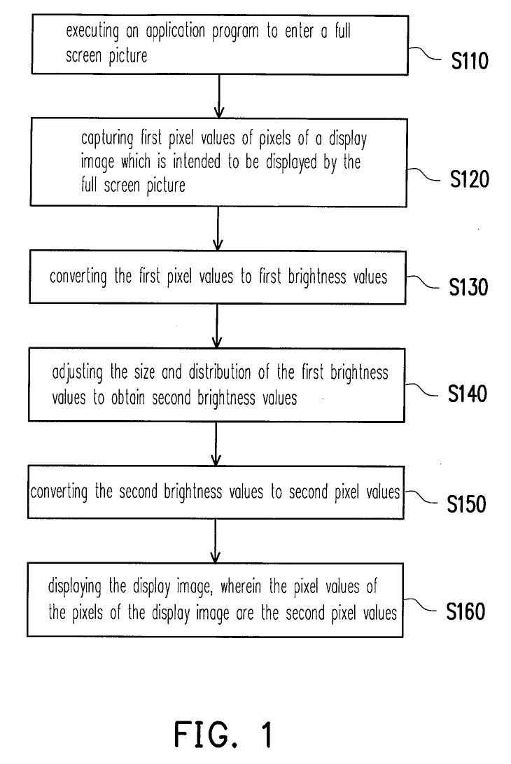

FIG. 1 is a flow chart showing steps of a method for dynamically adjusting the brightness of an image according to one embodiment of the invention. As shown in FIG. 1, first, in the step S110, an application program is executed to enter a full screen picture, and the application program may be, for example, a game program or a three-dimension (3D) animation, and so on. In the embodiment, the function of adjusting the brightness is set to be started when the application program begins to be executed with the full screen picture; a function hot key may be disposed to execute various functions such as the function of adjusting the brightness of the screen. The above implementing methods are examples, and they do not limit the scope of the invention.

Afterward, the brightness of the screen begins to be adjusted dynamically. In the step S120, a subsequent display image which is intended to be displayed on the full screen picture by the application program is captured to obtain the first pixel value of each pixel of the display image. The first pixel values are stored in a system memory, and the system memory may be the memory space on a graphics card. For example, taking a display image whose resolution is 800×600 with 256 colors (8 bits) as an example, a system memory which has the space of 800×600×8 bits is needed.

The resolution of present screens becomes higher and higher. If all pixels of the whole screen are correspondingly converted directly, a great deal of computing time is intended to be consumed, and loads of a graphics process unit (GPU) or a central process unit (CPU) increase. Therefore, if the computing capability of a hardware device is insufficient, the execution speed of the application program seriously becomes slow.

To avoid the above condition, in the embodiment, the step of adjusting the resolution of the display image is executed to appropriately scale the display image. The resolution of the display image decreases. That is, the number of the pixels which need to be computed decreases. Therefore, the computing speed also increases. Although the image may have some distortion after scaled, the corresponding brightness is still maintained in the scaled display image, which does not affect the subsequent step of adjusting the brightness values. The action of adjusting the resolution can be appropriately adjusted according to the level of the hardware device of a user. When the computing capability of the hardware device of the user is sufficient, it is unnecessary to adjust the resolution of the display image, and the original display image can be directly processed.

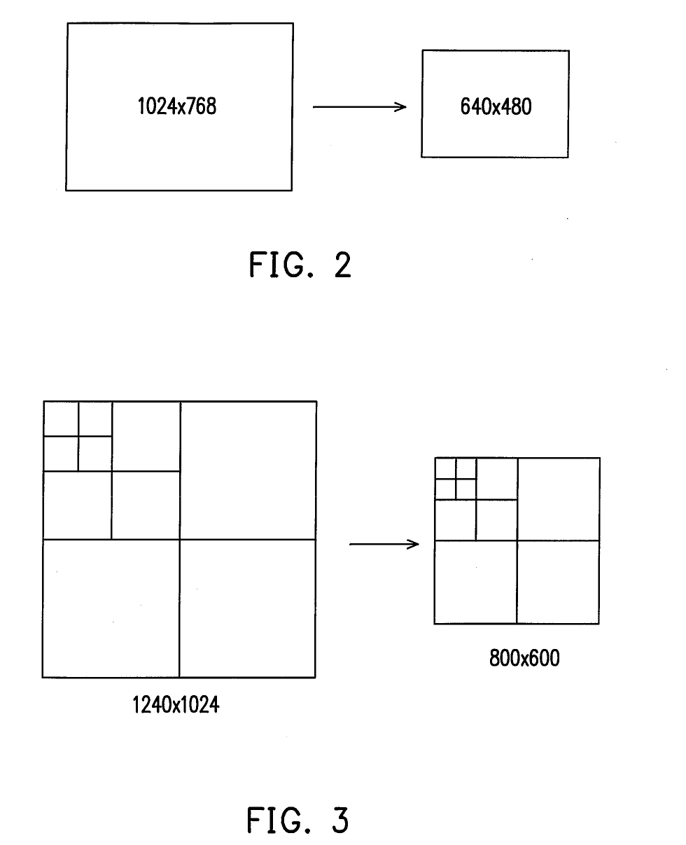

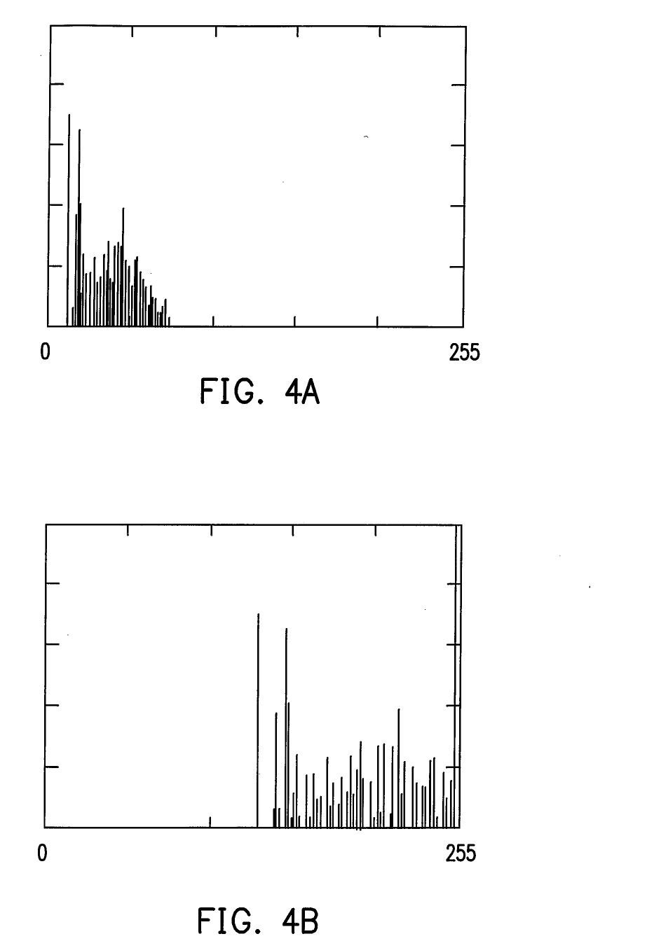

The method for adjusting the resolution of the display image is illustrated hereinbelow. FIG. 2 and FIG. 3 are schematic diagrams showing that an image is scaled according to one embodiment of the invention. As shown in FIG. 2, the method gives whole consideration to the brightness of the whole display image, and the whole display image is scaled according to a predetermined scale. In other words, the resolution of the display image is adjusted from 1024×768 to 640×480. Then, the first pixel values are converted to the first brightness values according to the adjusted result to continue the subsequent steps.

As shown in FIG. 3, the display image is equally divided into a plurality of macro blocks according to the method, and the display image is scaled according to the predetermined scale by aiming at each of the macro blocks. Content of most images consists of a plurality of objects, and light sources and light intensity for each object may be different. Therefore, the display image whose resolution is 1240×1024 can be equally divided into a plurality of macro blocks, and it is usually divided into 4^{x} macro blocks, such as 64 macro blocks. Then, the size of one macro block is 155×128, and the resolution of the macro blocks is individually adjusted to continue subsequent actions.

As shown in FIG. 1, in the step S130, the first pixel values of the pixels are converted to the first brightness values. In other words, a color space whose brightness and chrominance are separated is used to distinguish the pixel values to obtain the first brightness values. The advantage of the above conversion is that only the brightness is processed without affecting the color of the original display image.

For example, the common color space used by the present screens on the market is a RGB model. In the RGB model, each color consists of three elements such as red (R), green (G) and blue (B). That is, the first pixel values of the display image consist of the three elements R, G and B. Values of R, G and B are affected when the brightness is adjusted, and therefore, the R, G and B are unsuitable to be used to adjust the brightness. Therefore, if a user wants to adjust the brightness of the display image, he needs to convert the color space of the display image to avoid affecting the color of the original display image.

In the embodiment, the used color space is, for example, a YUV model, but it is only an example and does not limit the scope of the invention. In the YUV model, each color also consists of three elements, namely, brightness (Y) and two chrominances (U and V). Computing formulas for converting the RGB model to the YUV model are shown as follows:

Y=0.257×R+0.504×G+0.098×B+16 (1)

U=−0.148×R−0.291×G+0.439×B+128 (2)

V=0.439×R−0.368×G−0.071×B+128 (3)

wherein in the embodiment, only the first formula is used to convert the first pixel values to the first brightness values (namely, values of Y).

Afterward, in the step S140, the size and distribution of the first brightness values are adjusted to obtain the second brightness values. That is, the brightness of the display image is adjusted via algorithm. Different algorithm can cause different computing complexity.

For example, the algorithm may be executed as follows. The minimum and maximum values of the first brightness values are mapped to minimum and maximum brightness values in a specific brightness range, respectively, and the other first brightness values are mapped to corresponding brightness values in the brightness range. For example, an image histogram equalization method may be used, and the method is executed as follows. An image histogram of the first brightness values of the display image is obtained first, and then the image histogram is equalized to obtain the second brightness values.

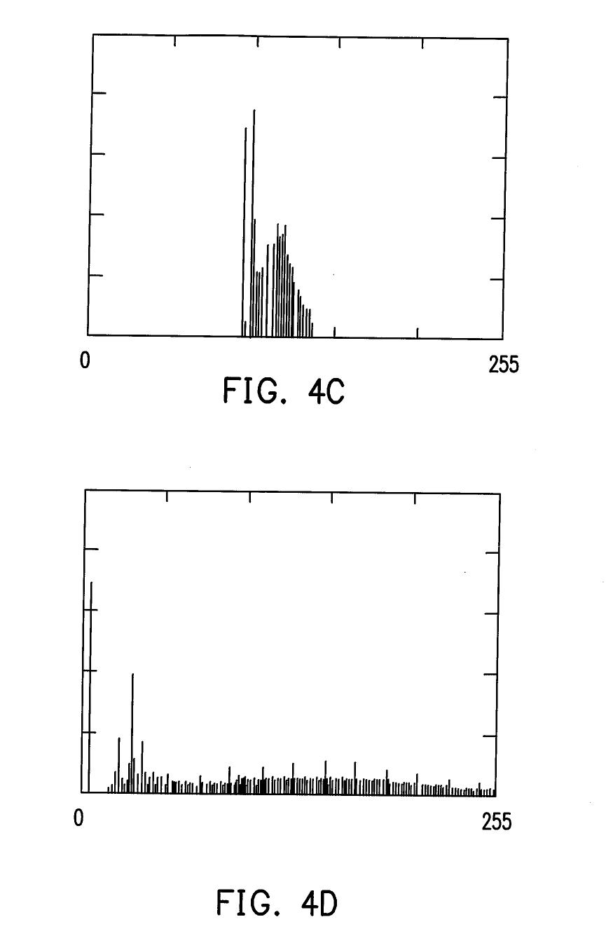

In detail, the called image histogram is a statistical chart established on a whole displayed image and brightness range of every pixels stored. FIG. 4A to FIG. 4D are schematic diagrams showing image histograms according to one embodiment of the invention. As shown in FIG. 4A to FIG. 4D, the distribution of the brightness of each pixel in the whole display image can be known from the image histograms. Assume that the brightness range is 0 to 255 (8 bits), and the brightness range can be divided into three parts. As shown in FIG. 4A, if the content of the image histogram is concentrated at a zone adjacent to zero, the display image is darklight; as shown in FIG. 4C, if the content of the image histogram is concentrated at a middle zone, the display image is midtone; as shown in FIG. 4B, if the content of the image histogram is concentrated at a zone adjacent to 255, the display image is highlight. Therefore, it is easy to determine the brightness range to which the content of the display image is adjacent from the statistical result of the image histogram.

The image histogram can also be used to describe the contrast of the display image. The called contrast is the sensing degree for distinguishing the difference between bright and dark. Taking the image histogram as example, if the content of the image histogram covers a broad brightness range and is equally distributed, it shows that the display image has high contrast, as shown in FIG. 4D; if the brightness range covered by the content of the image histogram is narrow, and the content of the image histogram is concentratedly distributed in a zone, it shows that the contrast of the display image is low, as shown in FIG. 4A, FIG. 4B or FIG. 4C.

The image histogram is a chart showing the relationship between each first brightness value in the brightness range and its corresponding probability, and the chart is drawn according to the probability density function (PDF) Pᵣ(rₖ) of the first brightness values of the display image. The computing formula of the PDF Pᵣ(rₖ) is shown as follows:

$${P}_{r} ( {r}_{k} ) = \frac{{n}_{k}}{n} , k = 0 , 1 , 2 , … , L - 1 \qquad ( 4 )$$

wherein k denotes the brightness values in the brightness range (zero to L−1), rₖ denotes the k-th brightness value in the brightness range, nₖ denotes the number of the first brightness values whose values are k, n denotes the total number of the first brightness values, and L denotes the maximum brightness value in the brightness range. Taking an 8-bit display image as an example, L is 256 (2⁸). That is, the brightness range is 0 to 255. The image histogram is shown as a plane coordinates diagram. That is, Y axis denotes Pᵣ(rₖ), and X axis denotes rₖ.

For example, for the first brightness values of the pixels of the display image, if the number of the first brightness values equaling to zero (k) is 3000, and the total number (n) of the first brightness values is 480000 (if the resolution of the display image is 800×600), the PDF Pᵣ(rₒ) of the rₖ which is zero is 3000/480000=1/160, and so forth.

When the image histogram of the first brightness values of the display image is obtained, the image histogram equalization can be executed. The image histogram equalization is that the brightness range is equally distributed to all pixels in the display image to allow the image histogram to uniformly distribute, and the computing formula is shown as follows:

$${S}_{k} = T ( {r}_{k} ) = {\sum }_{j = 0}^{k} {P}_{r} ( {r}_{j} ) = {\sum }_{j = 0}^{k} \frac{{n}_{j}}{n} , k = 0 , 1 , 2 , … , L - 1 \qquad ( 5 )$$

The second brightness values Sₖ is obtained via the fifth formula to map the pixel values whose first brightness values are rₖ to the second brightness values Sₖ.

Afterward, in the step S150, the second brightness values are converted to second pixel values. In other words, a color space which is supported by the screen is obtained by conversion. For example, if in the step S130, the color space is converted to the YUV model from the RGB model, the color space needs to be converted back to the RGB model from the YUV model now. The computing formula for converting the YUV model to RGB model is shown as follows:

R=1.164×(Y−16)+1.596×(V−128) (6)

G=1.164×(Y−16)−0.813×(V−128)−0.391×(U−128) (7)

B=1.164×(Y−16)+2.018×(U−128) (8)

During the computing process, only the brightness (namely, Y) is concerned, and therefore, in the sixth to eighth formulas, There only needs to replace the first brightness values of Y to the second brightness values (that is, rₖ is mapped to Sₖ), and the values of U and V are maintained to be the values obtained in the step S130. Then the second pixel values can be obtained by compute.

Finally, in the step S160, the display image is displayed on the image, and the pixel values of the pixels of the display image are adjusted to be the second pixel values. That is, the brightness of the finally displayed display image is appropriately adjusted, and then the problem that a single display image is over dark or over bright can be solved. In the embodiment, after the second pixel values are obtained, the second pixel values are written to the system memory to update the first pixel values stored in the system memory.

To sum up, in the embodiment, the step of converting the RGB model to the YUV model is taken as example, and the resolution of the display image is adjusted before displayed via the driver of the graphics card to appropriately scale the display image, and the scaled display image is stored in the system memory. Then, the scaled display image can be used as a reference to obtain a conversion result after equalization. First, the color space of the scaled display image is converted to be the YUV model, and the image histogram of the brightness of the display image is obtained. Via the image histogram equalization, a conversion result is obtained after the brightness is equalized. Then, the result of equalization is used to replace the brightness values of the original display image to adjust the brightness range of the whole display image. Finally, the YUV model is converted back to the RGB model, and the converted display image is displayed on the screen via the driver of the graphics card.

In the above embodiment, it is not limited to do the step of adjusting the brightness of each display image, and it can capture display images which is intended to be displayed by the full screen picture every a constant number of display images. The above steps for automatically adjusting the brightness of the image are repeated. The obtained second brightness values after adjusting the size and distribution are used to replace the first brightness values of each of the display images among the constant number of display images to continue the subsequent conversion. In other words, after the second brightness values of the first display image are obtained, the second brightness values of the first display image are used to replace the first brightness values of the subsequent display images of the constant number of display images to continue the subsequent conversion. Therefore, the step of computing the size and distribution of the first brightness values of the subsequent display images of the constant number of display images can be omitted to save computing time.

For example, the step of converting the RGB model to the YUV model is taken as an example, assume that a display image which is intended to be displayed by the full screen picture is captured every thirty display images, and the above steps for dynamically adjusting the brightness of the image are repeated. After the three elements Y (namely, the first brightness value), U and V of each pixel of the subsequent twenty-nine display images are obtained, the obtained second brightness values of the captured first display image are used to replace the Y value of each pixel of each subsequent display image. That is, the converted brightness values of the subsequent twenty-nine display images are the same with the converted brightness values of the first display image.

To sum up, the method for dynamically adjusting the brightness of the image has at least the following benefit effects.

First, under a full screen mode, a next display image which is intended to be displayed by an application program is captured, and the brightness of the display image is dynamically adjusted according to the brightness distribution of the display image. Therefore, each display image can be individually adjusted without the problem that the display images are flashing.

Second, the resolution of the display image can be appropriately scaled, and only the brightness values of part of the pixels are used to compute the brightness distribution, which saves the computing time and increases the computing speed.

Third, the brightness is adjusted every a constant number of display images. When the conversion result of the brightness of the first display image is obtained, it is used to replace the brightness of the subsequent display images, and it is unnecessary to compute the brightness of the display images one by one, which saves the computing time.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for dynamically adjusting the brightness of an image, which is suitable to dynamically adjust the brightness of at least a display image when an application program is executed with a full screen picture, the method for dynamically adjusting the brightness of an image comprising the steps of:
executing the application program to enter the full screen picture;
capturing a plurality of first pixel values of a plurality of pixels of the display image which is intended to be displayed by the full screen picture;
converting the first pixel values to a plurality of first brightness values;
adjusting the size and distribution of the first brightness values to obtain a plurality of second brightness values;
converting the second brightness values to a plurality of second pixel values; and
displaying the display image, wherein the pixel values of the pixels of the display image are the second pixel values.

2. The method for dynamically adjusting the brightness of an image according to claim 1, wherein the step of capturing the first pixel values of the pixels of the display image which is intended to be displayed by the full screen picture comprises the step of:
capturing the display image which is intended to be displayed by the full screen picture every a constant number of display images.

3. The method for dynamically adjusting the brightness of an image according to claim 1, wherein after the step of capturing the first pixel values of the pixels of the display image which is intended to be displayed by the full screen picture, the method further comprises the step of:
storing the first pixel values to a system memory.

4. The method for dynamically adjusting the brightness of an image according to claim 3, wherein after the step of converting the second brightness values of the pixels to the second pixel values, the method further comprises the step of:
overwriting the first pixel values in the system memory with the second pixel values.

5. The method for dynamically adjusting the brightness of an image according to claim 1, wherein before the step of converting the first pixel values of the pixels to the first brightness values, the method further comprises the step of:
adjusting resolution of the display image.

6. The method for dynamically adjusting the brightness of an image according to claim 5, wherein the step of adjusting the resolution of the display image comprises the step of:
scaling the display image according to a predetermined scale.

7. The method for dynamically adjusting the brightness of an image according to claim 5, wherein the step of adjusting the resolution of the display image comprises the steps of:
equally dividing the display image into a plurality of macro blocks; and
scaling the macro blocks according to a predetermined scale.

8. The method for dynamically adjusting the brightness of an image according to claim 5, wherein after the step of adjusting the resolution of the display image, the method further comprises the steps of:
obtaining an image histogram by statistics according to the resolution of the adjusted display image; and
adjusting the size and distribution of the first brightness values according to the image histogram.

9. The method for dynamically adjusting the brightness of an image according to claim 8, wherein the step of adjusting the size and distribution of the first brightness values comprises the step of:
equally distributing the first brightness values into a brightness range of the image histogram according to the image histogram.

10. The method for dynamically adjusting the brightness of an image according to claim 9, wherein the step of equally distributing the first brightness values into the brightness range of the image histogram comprises the steps of:
mapping a minimum value of the first brightness values to a minimum brightness value of the brightness range;
mapping a maximum value of the first brightness values to a maximum brightness value of the brightness range; and
mapping the other first brightness values to corresponding brightness values of the brightness range.

11. The method for dynamically adjusting the brightness of an image according to claim 8, wherein the step of obtaining the image histogram by statistics comprises the step of:
counting the number of the pixels whose pixel values are one of the first brightness values, respectively, to compute a probability density function Pᵣ(rₖ) of each of the first brightness values and obtaining the image histogram by combining each of the first brightness values and the corresponding probability density function Pᵣ(rₖ) thereof, wherein
$${P}_{r} ( {r}_{k} ) = \frac{{n}_{k}}{n} , k = 0 , 1 , 2 , … , L - 1 ,$$
wherein k denotes the brightness values in a brightness range, rₖ denotes the k-th brightness value in the brightness range, L denotes the maximum brightness value in the brightness range, n denotes the total number of the first brightness values, and nₖ denotes the total number of the first brightness values whose values are k.

12. The method for dynamically adjusting the brightness of an image according to claim 11, wherein the step of adjusting the size and distribution of the first brightness values comprises the step of:
equalizing the image histogram, wherein the step of equalizing the image histogram comprises the step of equally distributing the first brightness values to the brightness range to obtain the second brightness values to map the first brightness values rₖ of the pixels to the second brightness values Sₖ, wherein
$${S}_{k} = T ( {r}_{k} ) = {\sum }_{j = 0}^{k} {P}_{r} ( {r}_{j} ) = {\sum }_{j = 0}^{k} \frac{{n}_{j}}{n} , k = 0 , 1 , 2 , … , L - 1.$$

13. The method for dynamically adjusting the brightness of an image according to claim 1, wherein the application program executed with the full screen picture comprises a game program.
